(19) United States
(12) Patent Application Publication
(10) Pub. No.: US 2014/0198206 A1
(43) Pub. Date: Jul. 17, 2014

(54) System and Method for Estimating the Position and Orientation of an Object using Optical Beacons

(71) Applicant: Kevin Hugh Murray, Fairfax, VA (US)

(72) Inventor: Kevin Hugh Murray, Fairfax, VA (US)

(21) Appl. No.: 14/157,494

(22) Filed: Jan. 16, 2014

Related U.S. Application Data
(60) Provisional application No. 61/753,646, filed on Jan. 17, 2013.

(51) Int. Cl. H04N 7/18; G01C 3/02

(52) U.S. Cl. CPC H04N 7/181; G01C 3/02
USPC 348/135

(57) ABSTRACT

A system and method for determining the position and orientation of an object within an environment using optical beacons placed at known locations within the environment. The optical beacons are received by an imaging device mounted on the object to be positioned, The system derives the position and orientation of the object from data associated with the pixel locations of the beacons within images, the identity of the beacons within images, and the positions of the beacons within the environment. In one embodiment, the optical beacons emit signals that are patterned in such a way that they appear as a first signal when sampled a low sampling rate and appear as a second signal when sampled at a high sampling rate. The first signal is the same for each beacon, and is used to distinguish beacons from other sources of light in the environment. The second signal is different for each beacon, and is used to identify beacons. In another embodiment, the optical beacons are installed underground and rise on command. In another embodiment, the optical beacons may also emit light within an absorption band of the atmosphere m order to improve the signal to noise ratio of the beacons.

### CROSS-REFERENCE TO RELATED APPLICATIONS

This application claims the benefit of provisional patent application Ser. No. 61/753,646, filed Jan. 17, 2013 by the present inventor.

### FIELD OF THE INVENTION

The present invention relates to systems which provide location and orientation information to mobile vehicles. More particularly, the present invention relates to systems which obtain position and orientation information based on measured directions to fixed objects with known locations.

### BACKGROUND THE INVENTION

The ability to precisely measure position is an important feature in many mobile robotic applications. Two common classes of positioning techniques are trilateration and resection (often called triangulation). Both techniques allow a mobile robot to determine its position based on measurements to reference points of known position. Trilateration uses the distances measured to reference points, generally using the time of flight of some signal of known propagation speed (e.g. the speed of light or the speed of sound), and resection uses the relative directions measured to reference points.

When no other position information is provided, trilateration and resection both generally require as minimum of 3-4 reference points in order to calculate a position. A significant disadvantage of the resection technique is that the error in the calculated position is linearly dependent on the distance to the reference points. All else being equal, doubling the size of the working area requires the number of reference points to double. This may be prohibitively expensive for very large working areas. However, a significant benefit of the resection technique is that the direction measurements can be made with high-precision and at a low cost with digital image sensors. Resection is thus seen as an attractive positioning technique for relatively small working areas where only a modest number of reference points are required.

The prior art commonly makes use of digital image sensors as the direction measuring device, but there are a variety of designs for the reference points. Generally, the reference points need to be readily recognized in images and to convey their positions. In some eases, the reference points are fiducial markers: two-dimensional symbols or patterns that can be readily distinguished from the environment. In U.S. patent application Ser. No. 13/253,827, Publication No. 20120085820 (published Apr. 12, 2012)(Michael Morgan, applicant), barcodes between two colored, circles are used as reference points. The two circles are the fiducial marker used to recognize the reference point within the field of view of the image sensor. The barcodes are encoded with position coordinates of the beacons or with an identification number that can be used to retrieve position coordinates from a lookup table. One advantage of these reference points is that they require no power as long as there is sufficient ambient lighting. Another advantage is that the since the position information of as reference point is encoded into a two-dimensional pattern, this information can be decoded from a single image of the pattern. A significant disadvantage of this approach, however, is that the marker may be difficult to recognize from different orientations and in different ambient lighting conditions.

Another type of reference point is a powered optical beacon. This could be any artificial light source, such as an incandescent light bulb or as light emitting diode. A disadvantage of this method is that detecting artificial light sources can be difficult due to the high-brightness of other sources of light in the environment, such as sunlight and artificial illumination. An advantage of this technique is that the beacon can be a point-like light source, and thus appear the same from any orientation and in different ambient lighting conditions. Unlike the two-dimensional patterns used in fiducial markers, the optical beacon can only emit to temporal pattern (i.e. a signal) in order to maintain the advantage of using a point-like light source.

Although not specifically designed as a positioning system, Matsushita et al “ID CAM: A Smart Camera for Scene Capturing and ID Recognition” Proc. ISMAR 2003 (Tokyo, 8-12 Oct. 2003), pp. 227-236 describes a system that identifies optical beacons. Each beacon continually emits a 22 bit signal at 4,000 hertz that uniquely identifies the beacon. A specially designed camera system samples each of its 23,808 pixels simultaneously at 12,000 hertz in order to detect beacon signals. The beacon ID and pixel coordinates of any detected beacons are then sent to a computing device over USB. The advantage of this system is that every pixel can detect and identify a beacon in a short period of time. The disadvantage of this method is that it requires a specially designed camera system. The ability to sample every pixel at 12,000 hertz may be prohibitively expensive, especially for as positioning system that requires one to several million pixels in order to provide direction measurements at sufficient precision.

An alternative approach seen in sonic resection positioning systems is to use image sensors only for detecting beacons, not for identifying beacons. Beacons generally emit a signal so they can be distinguished from the environment, but this signal is much shorter than an identification signal and thus does not require very high sampling rates. Both U.S. Pat. No. 5,974,348 (Rocks, Oct. 26, 1999) and U.S. Pat. No. 7,739,034 (Farwell, June 15, 2010) describe positioning systems that use modulating beacons in order to distinguish the beacons from environmental light. In Rocks's invention, a mobile robot uses image sensors to image a 360 degree field of view while the beacons are off, then immediately signals for the beacons to be turned on, and another 360 degree field of view is captured by the image sensors. Since the time between these two images is short, the environmental lighting is expected to be nearly the same in both images. Thus, by subtracting the first image from the second image, only the light from the beacons will remain. Farwell's invention works in a similar fashion. Instead of having the robot signal for the beacons to be turned on, the beacons continually blink on and of at a 50% duty cycle and image sensors on the robot capture images at a frame rate that is twice the beacon blink frequency. Like Rocks's invention, image frames are subtracted from one another in order to distinguish beacons.

While these methods work well to distinguish beacon light front environmental light, they lack the ability to identify individual beacons. In Rocks's invention, no attempt is made to identify the detected beacons. Instead, the system requires 7 beacons to he detected. This allows multiple beacon identifications to be matched with the detected beacons, and the matching that best fits the observed directions is assumed to be the correct solution. But if the beacons could be identified (and their positions made known), the resection technique would only require 3-4 beacons to be detected, The fact that Rocks's invention requires about twice as many beacons to he detected means that either many more beacons are required in the working area, or the beacons must be detectable at much greater distances. In addition, the beacons must be spaced in an irregular pattern in order to obtain a unique solution. If the beacons were placed in the corners of a heptagon, for example, there would he no unique position and orientation solution.

In Farwell's invention, beacons can he identified based on previous identifications. If a beacon is detected and identified at as particular location within an image, the identity of that beacon can be tracked as it moves within the image frame. However, as Farwell notes, the initial beacon identifications cannot he determined this way. The system can only identify beacons that it has previously identified, and the motion of the robot cannot have greatly altered the position of the beacons within image frames. If either the position or the orientation has significantly changed since the last beacon detection, the system requires some other means to identify the beacons and thus calculate a position.

U.S. Pat. No. 7,613,544 (Park, Nov. 3, 2009) describes a simple method of identifying modulating beacons. A mobile robot signals for all but one beacon to be turned off, so that if as beacon is detected, its ID is matched to the single active beacon. This process is repeated until a satisfactory number of beacons within the field of view of the robot are identified. While this method is robust, it has two disadvantages. The first disadvantage is that it may take a substantial amount of time to identify beacons, especially if a matching attempt needs to be made for every beacon in the environment. The second disadvantage is that this process would interrupt other robots using the beacons.

The use of modulating, optical beacons in a resection-based positioning system is seen as a favorable method of detecting beacons among other sources of light. However, there is a need for a system that can robustly and inexpensively identify the detected beacons in a short period of time, without interrupting other users of the beacons.

Modulating the emissions of beacons is a useful method of distinguishing beacons from the environment, but it may not be sufficient in some environments. Outdoor areas during the day are an especially challenging environment, simply due to the magnitude of sunlight. Beacons can he made more distinguishable by having them emit a narrow spectrum of light, and filtering light outside this spectrum before it reaches the image sensors. U.S. Pat. No. 5,235,513 (Velger, Aug. 10, 1993) describes an optical beacon positioning system that uses optical filters matched to the spectral hand of the beacons in order to improve the signal-to-noise ratio. Combining this technique with modulating beacons may be necessary when there is a high amount of environmental lighting. New methods of increasing the signal-to-noise ratio would be beneficial because they would allow for dimmer beacons, which would decrease the costs of the emission source, thermal management of the emission source, and power distribution.

Another major consideration is the design and layout of the beacons, but there is little detail of this in the prior art. Farwell simply notes that in indoor applications, beacons can he placed on walls or ceilings, and in outdoor applications, beacons can be placed on vertical structures, such as exterior building walls. One issue with this idea is that some outdoor environments do not or cannot have sufficient vertical structures. In Rock's invention, beacons are placed at intervals along the perimeter of the working area. While this keeps the beacons from interfering with anything in the working environment, it may be impractical for large areas or areas with widely varying terrain. For larger areas, the distances to beacons would be greater, and this the precision of the image sensors would need to be greater in order to maintain a certain precision in the position calculations. Widely varying terrain may occlude the beacons along the perimeter.

There is a need for beacons that can be placed within the working area without interfering, with any activities in the working area. Additionally, there is a need for beacons that do not significantly affect the aesthetics of areas where aesthetics are important (e.g. golf courses and yards).

### SUMMARY

The present invention involves a system that provides precision position and orientation estimates to a mobile vehicle operating in a known environment. This is accomplished by placing beacons at known locations in the environment. An imaging system on the vehicle images a wide field of view to detect and identify beacons. Directions (unit vectors) to beacons are determined based on the pixel coordinates of the beacons within images. These directions along with the three-dimensional coordinates of the beacons, allow the system to calculate the position and orientation of the vehicle using the resection for triangulation) technique. The present invention improves this system with three main techniques.

The first improvement is having the beacons emit light in a manner such that two different sampling rates receive two apparently different signals. In particular, a certain low sampling rate causes the received signals of all beacons to appear the same. This signal is used to distinguish the beacons from environmental light. A certain high sampling rate causes the received signals of all beacons to appear different, which allows the system to identify beacons that are detected in images.

The second improvement is having the beacons buried underground and provided with a means of raising themselves as needed. Beacons remain buried until needed and lower themselves to avoid collisions with the robot.

The third improvement is having the beacons emit light in a narrow spectrum within an absorption band of the atmosphere. The imaging device uses narrow optical bandpass filters with allowed wavelengths matching the beacon emission spectrum.

### Advantages

The advantage of the first improvement is that the system can quickly identify beacons on demand, without interrupting other vehicles that may be using the beacons. The identification process requires no additional equipment because it takes advantage of the random pixel access feature common in low-cost image sensors.

The advantage of the second improvement is that the beacons can he lowered underground so that the do not interfere with other processes occurring in the working area. This allows beacons to he placed within the working area instead of confined to the perimeter, as done by others in the prior art. Having beacons within the working area increases the precision of the position measurements and/or allows the system to be applied to larger areas. Beacons can also be individually lowered based on the position and intended path of the vehicle in order to avoid collisions with the vehicle. This is especially advantageous when the vehicle is performing lawn maintenance (e.g. mowing and leaf removal) because it allows the vehicle to pass directly over the beacons.

The advantage of the third improvement is that the system uses the atmosphere as a filter for extraterrestrial light. This is beneficial because sunlight is by far the largest source of optical noise in this type of system,

### BRIEF DESCRIPTION OF THE DRAWINGS

in the drawings, closely related figures have the same number, but different alphabetic suffixes, FIG. 1 shows a vehicle receiving direction measurements to beacons which have been placed in the environment.

FIG. 2 shows as particular omnidirectional imaging, system formed by aligning a camera with a conical mirror.

FIG. 3 shows a particular omnidirectional imaging system formed using three cameras oriented in a triangle.

FIG. 4 illustrates the timing of an optical signal emitted by a beacon and the low and high sampling rates of an imaging system.

FIGS. 5A and 5B illustrate portions of images captured by an imaging system at the low sampling rate of the imaging system.

FIGS. 6A through 6F illustrate image regions of interest captured by an imaging system according at the high sampling rate of the imaging system.

FIG. 7 is a flowchart of the positioning methodology according to an embodiment of the present invention.

FIGS. 8A, 8B, 8AS, and 8BS show a buried beacon in both its lowered and raised state as well as section views of its lowered and raised state.

FIG. 9 shows buried beacons in an environment, connected to a beacon network controller.

FIG. 10 is a flowchart of the methodology the beacon network controller uses to continually adjust the heights of the beacons.

FIGS. 11A and illustrate the sunlight spectrum at the to and bottom of the atmosphere, respectively.

### DETAILED DESCRIPTION

The detailed description has four main sections. The first section describes a resection-based positioning system using optical beacons, This first section is the :foundation from which the remaining three sections improve upon. The first section is similar to multiple embodiments in the prior art, but is included here in order to make clear what the remaining three sections improve upon.

### FIGS. 1, 2, and 3—Foundation

Referring to FIG. 1A, a vehicle is shown at reference numeral 100 that moves about within a working area shown at reference numeral 105. The vehicle may be a mobile robot that performs some operation, such as landscaping or cleaning, within the working area. The working area may be an outdoor area (e.g. a yard) or an indoor area (e.g. a room in a home or a warehouse). Beacons 101A, 101B, and 101C are positioned at known locations in the working area 105. The working area may extend beyond what is shown in the figure, and there may be more beacons positioned throughout the working area.

A position sensor 106 is shown mounted on the vehicle 100. The position sensor is comprised of an imaging system 102 and a computing device 103. The position sensor uses the resection technique to calculate the position and orientation of the vehicle 100. Imaginary line segments 104A, 104B, and 104C connect a known point on the vehicle (e.g. the center of the position sensor) to beacons 101A, 101B, and 101C, respectively, The lengths of these line segments are generally unknown and not directly measured by the position sensor. Instead, the position sensor measures the direction (i.e. a three-dimensional unit vector) of these line segments, relative to the vehicle. When the directions to at least 3 beacons are measured, the position sensor 106 can calculate a position and orientation of the vehicle 100, relative to the beacons.

The directions to beacons are measured by the imaging system 102. Every pixel in the imaging system is associated with a direction relative to the imaging system. Directions can be mapped to the pixels by measuring, the intrinsic parameters of the imaging system. The direction to a beacon can thus be found by locating the beacon in an image and obtaining the direction of the pixel that best represents the beacon (e.g. the pixel at the center of the beacon in the image). hi addition, the position and orientation of the imaging system relative to the vehicle 100 must he known. This can be achieved by measuring the extrinsic parameters of the imaging system. Many techniques for measuring the intrinsic and extrinsic parameters of various imaging systems are known in the art.

The computing device 103 includes a data processing component, memory, and a means of communicating with the imaging system 102. The coordinates and identities of the beacons are stored in the memory of the computing device. The computing device controls the imaging device, receives image data and stores it in memory, processes the image data to detect and identify beacons, determines the directions to beacons based on the pixels in which they appear, and finally calculates a position and orientation based on the measured directions to beacons.

As the vehicle 100 moves about the working area 105, beacons may be viewable from any direction around the vehicle. Thus in most cases, the position sensor 106 must be able to detect beacons from multiple directions around the vehicle, In order to achieve this, the imaging system 102 must be an omnidirectional imaging system.

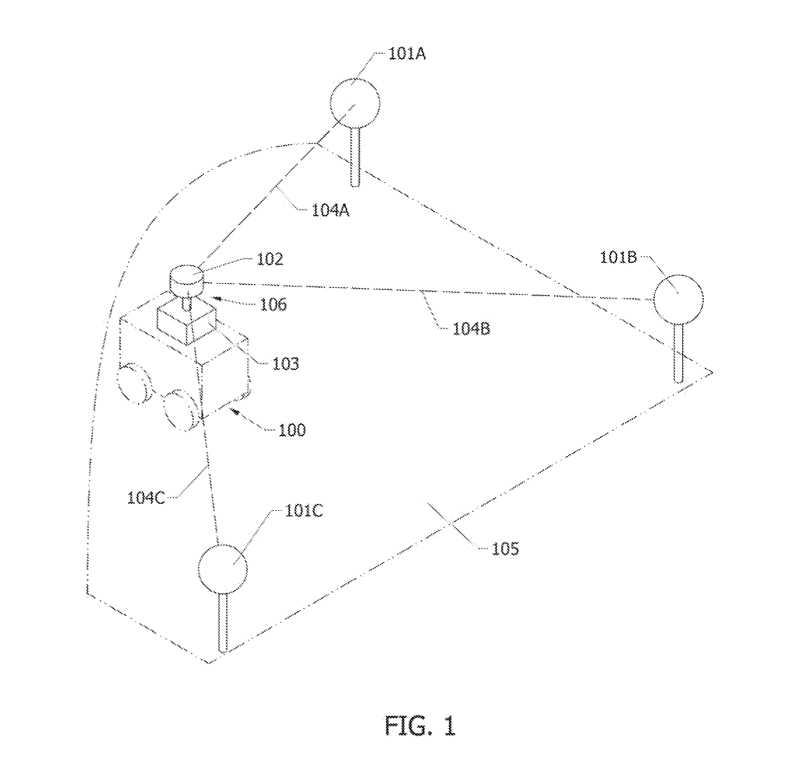

Referring to FIG. 2, a portion of ail omnidirectional imaging system is shown. A camera 201 is shown aligned with a conical mirror 299, which produces a 360 degree panoramic field of view, Other mirror shapes (e.g. spherical, hyperbolic, and parabolic) could also produce a 360 degree panoramic field of view, The camera is composed of a circuit board 202 with image sensor 205, lens assembly 204, and optical filter 210. A computing device interface 203 allows the camera to be connected by some means (e.g. universal serial bus) to the computing device 103. The computing device controls the camera via the computing device interface and the camera transmits images to the computing device via the computing device interface. Light from directions 207 and 208 is shown reflecting off the conical mirror and crossing the image plane 206 at pixel locations 207A and 208A, respectively. In this way, each pixel can be associated with a particular direction. When a beacon is detected at a particular pixel, the direction to the beacon is the direction associated with that particular pixel. The position and orientation of the camera-mirror system relative to the vehicle 102 must be known.

Referring to FIG, 3, a portion of another omnidirectional imaging system is shown. Cameras 301A, 301B, and 301C are oriented in a triangle in order to provide a wide panoramic view, The cameras are composed of circuit boards 302A, 3028, and 302 with image sensors 305A, 395B, and 305C, lens assemblies 304A, 304B, and 304, and optical filters 399A, 399B, and 309C. Computing device interfaces 303A, 303B, and 303C allow the cameras to be connected by some means (e.g. universal serial bus) to the computing device 103. Light. from directions 307A, 307B, and 307C cross image planes 306A, 306B, and 307 at pixel locations 308A, 308B, and 308C, respectively. In this way, each pixel can be associated with as particular direction. When as beacon is detected at a particular pixel, the direction to the beacon is the direction associated with that particular pixel. The position and orientation of each camera relative to the vehicle 102 must he known. More than three cameras may he used and the cameras may have varying fields of view.

### FIGS. 1, 4, 5A, 5B, 5A through 5F, and 7—First Embodiment

The first embodiment improves upon the foundation b providing as robust design and method for both detecting and identifying beacons. The image sensor(s) within the imaging system 102 are of a type that allows random pixel access. The random pixel access feature allows individual pixels or small groups of pixels to be sampled at a rate that is significantly higher than the full-frame rate of the camera. For example, a typical image sensor with this capability may have a 60 hertz frame rate, but allow small groups of pixels to be sampled at 400 hertz or more. Sampling a small portion of the image sensor is often called windowing or region of interest mode, Henceforth, the frequency that full images (i.e. all pixels) are sampled will he referred to as the full-frame rate and the frequency that a small group of pixels are sampled will be referred to as the partial-frame rate. The partial-frame rate is at least twice the full-frame rate, and may be several orders of magnitude higher.

The beacons are powered optical beacons that emit light (infrared, visible, or ultra-violet), using a light source such as light emitting diodes. The beacons emit optical signals by modulating their brightness. The signals are formed in such a way that when they are sampled at the full-frame rate, they all appear to be transmitting the same simple signal. This simple signal is referred to as the beacon distinguishing signal, and is used to distinguish beacons from other light in the environment. When as beacon is sampled at the partial-frame rate, however, it appears to be emitting a unique data signal. The data signal is different fir each beacon and can he used to uniquely identify beacons. The data signal is referred to as the beacon identification

The position sensor 106 can search for beacons across the entire field of view of the imaging system 102, at the full-frame rate of the image sensor(s). When a beacon is detected at a certain pixel location within an image sensor, the image sensor can set up is region of interest at that pixel location and sample the region of interest at the partial-flame rate in order to identify the beacon.

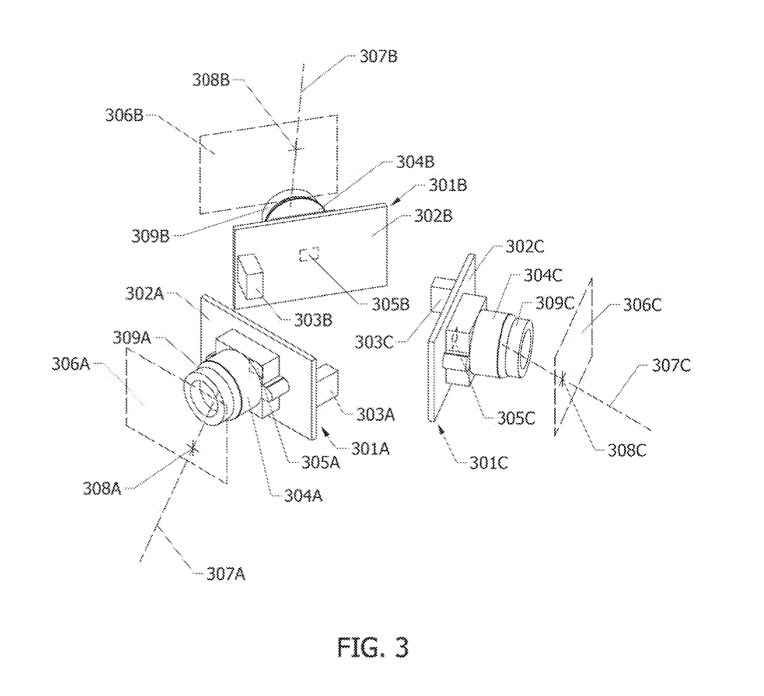

FIG. 4 illustrates an example of this. The waveform of a particular beacon is marked by BS (beacon signal) in FIG. 4. This beacon emits a 6-bit beacon identification signal (‘101101’) over as period of time T1. A high bit (‘1’) is represented by the beacon being on for period of time T2 and a low bit (‘0’) is represented by the beacon being off for period of time T2. After emitting the 6-bit signal, the beacon is then of for period of time T1, then again emits the 6-bit digital signal over period of time T1, followed again by an off state for period of time T1. This waveform repeats indefinitely. In this way, a meta-signal is produced, where the meta-signal is defined to be high (‘1’) if the 6-bit signal is being emitted and low (‘0’) if the 6-bit signal is not being emitted. Thus the meta-signal in this example is a 2-bit signal (‘10’), which is shown twice in FIG. 4. This meta-signal is the beacon distinguishing signal. Every beacon emits the same beacon distinguishing signal, but a different 6-bit signal within the beacon distinguishing

The position sensor 106 can search for beacon distinguishing signals within the entire field of view of its imaging system 102 at the full-frame rate of the imaging sensor(s). The full-frame exposure and frame rate are illustrated by the FES waveform in FIG. 4. The high portions within the FFS waveform indicate that the frame is being exposed for time E1 and the time period between exposures F1 defines the full-frame rate of the imaging sensor. Since the first exposure occurs during high portions of the BS waveform, the beacon will be imaged if it is within the field of view of the imaging system.

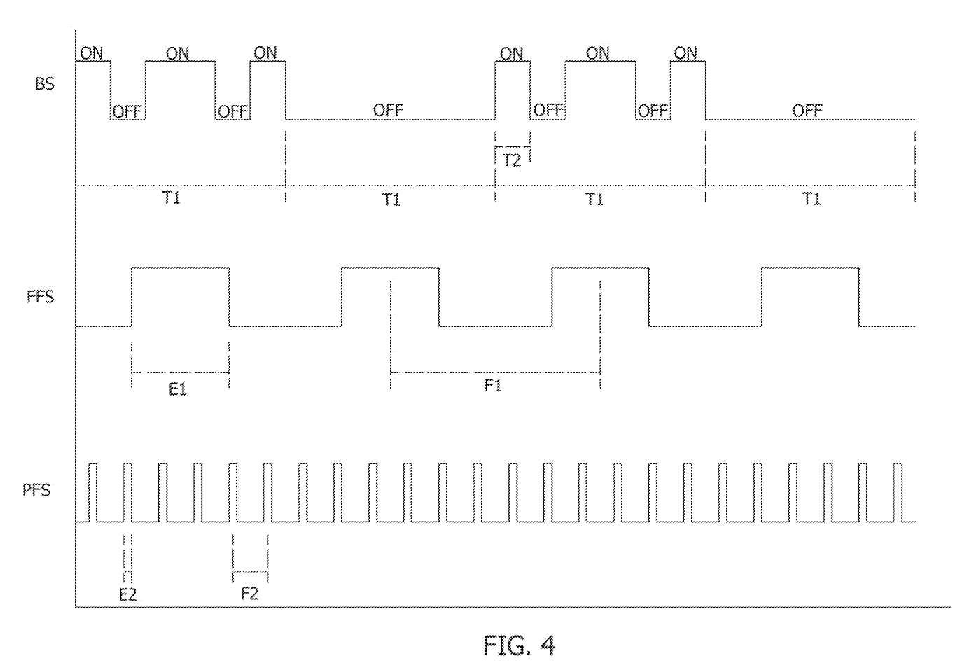

FIG. 5A shows an example of a portion of the image formed during the first exposure in the ITS waveform, The grid in FIG. 5A represents a portion of the pixel array in an image sensor. Circles 502 and 503 represent the imaging of environmental sources of light (e.g. sunlight or artificial illumination) at pixels P2 and P3, respectively. Circle 501 represents the image of the beacon emitting the BS waveform at pixel P2. The beacon is imaged because the first exposure occurs during high portions of the BS waveform. The second exposure in the FES waveform occurs during a completely low portion of the BS waveform, so the beacon will not be imaged, even if it is within the field of view of the imaging system. FIG. 5B shows a partial image of what might be detected during the second exposure in the FFS waveform. Because the second exposure occurs shortly after the first exposure, and because most environmental sources of light do not significantly modulate, the environmental sources of light in the first exposure (numerals 502 and 503) appear at the same pixels in the second exposure. Since these two sources of environmental light are detected in consecutive exposures, the received signal would be ‘11’ at pixels P2 and P3, which is inconsistent with the beacon distinguishing, signal of ‘10’ Since the beacon represented by 501 is detected in the first exposure and not in the second, the received signal at pixel P1 would be ‘10,’ which is consistent with the beacon distinguishing signal.

With a beacon detected at pixel P1, the imaging system can set up a region of interest around pixel P1 and sample this region of interest at the partial-frame rate in order to identify the beacon. The partial-frame rate sampling is illustrated by the PFS waveform in FIG. 4, The high portions within the PFS waveform indicate that the region of interest is being exposed for time E2 and the time period between exposures F2 defines the partial-frame rate of the region of interest.

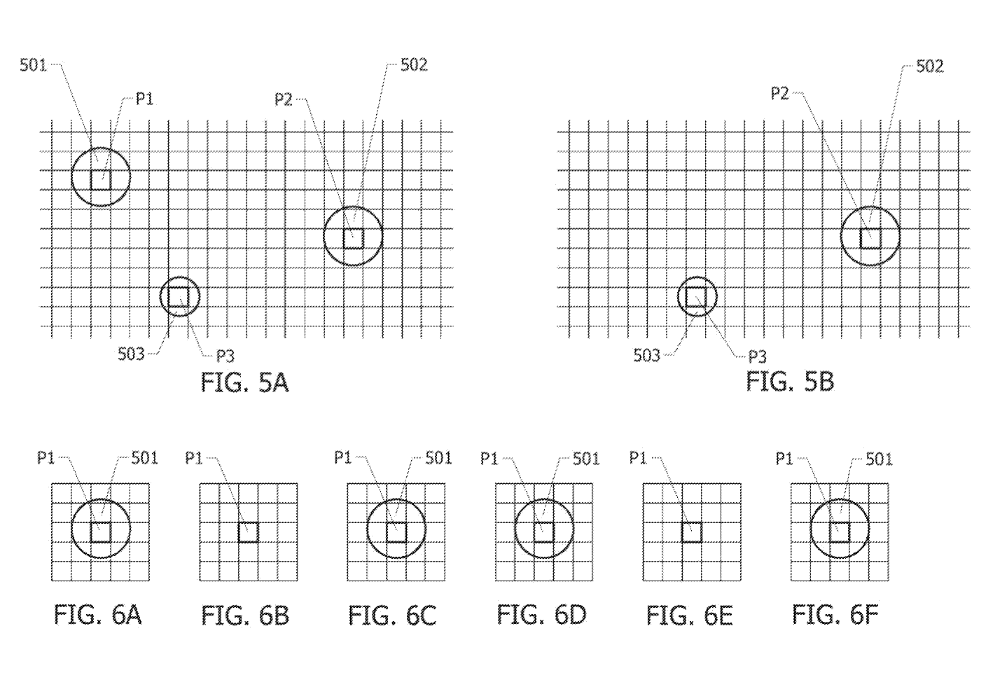

FIG. 6A through 6F represent the first six exposures in the PFS waveform of the region of interest surrounding pixel P1. Since the first, third, fourth, and sixth exposures in the PFS waveform align with the high portions of the Bs waveform, the beacon is imaged in FIGS. 6A, 6C, 6D, and 6F. The beacon is low during the second and fifth exposures, so it is not imaged. Thus the imaging system receives the signal ‘101101,’ which matches the beacon Identification

Note that while the FIG. 4 shows the BS signal being synchronized with the EFS and PFS waveforms, this is not necessary. Since the beacons continually repeat their signals, the imaging system can sample full signals multiple times to ensure the received signals are accurate. When the imaging system and the beacons are not synchronized, it may be necessary to have the beacon distinguishing signal emit, at a slightly faster or slower rate than the full-frame rate of the imaging system. This way, the exposure time cannot continually overlap the transition between high and low of the beacon distinguishing signal. To further minimize such overlaps, the exposure time can be shortened. In which case, it may be necessary to avoid beacon identification signals with long sequences of ‘0’ bits. This is because a shorter exposure time would he more likely to align with a long sequence of ‘0’ bits, and thus not detect the beacon distinguishing signal. Another technique in dealing with a lack of synchronization would be to lower the frequency of the beacon distinguishing signal or the beacon identification signal (or both signals) so that the imaging system performs multiple samples per bit.

There are many potential variations of the beacon identification and beacon distinguishing signals. The number of beacons that need to be identified in the manner previously discussed determines the number of bits required in the beacon identification signal. Other variations of the beacon distinguishing signal may also be useful. For example, a beacon distinguishing signal of ‘110’ can he created by emitting the beacon identification signal twice, followed by an off state. Such a beacon distinguishing signal may be beneficial because it would allow the pixel locations of beacons to be updated every two Out of three frames.

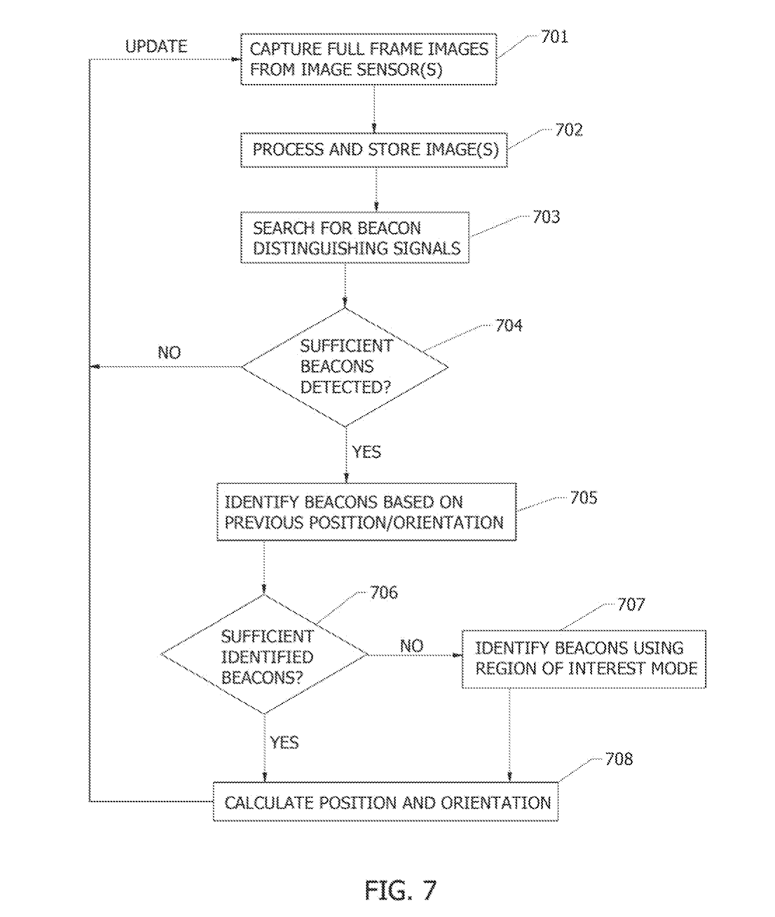

FIG. 7 shows a process for continually calculating the position and orientation of as vehicle 100. Each position/orientation update starts at 701, where lull frame images of the field of view (FOV) of the imaging system 102 are captured. Multiple images or the FOV are necessary when multiple image sensors are used in the imaging system. Neither the image sensors nor the pixels in the image sensors need to be synchronized, but synchronizing both would improve the position and orientation estimates when the vehicle is moving.

At 702, the FOV images are received into the memory of the computing device 103 and timestamped. The computing, device then processes and stores the images. Processing may involve image processing techniques (e.g. thresholding, dilation, erosion) in order to improve beacon detection.

At 703, the computing device searches for beacon distinguishing signals in the most recent sequence of FOV images, according to the method previously described. The image coordinates of each detected beacon are stored, along with their time of detection (according to the timestamp of the image the beacon is detected in).

At 704, the computing system determines whether a sufficient number of beacons have been detected in order to calculate a position/orientation. Generally, 3-4 beacons are sufficient. if an insufficient number of beacons are detected, the process restarts at 701. Depending on how long the process has gone with an insufficient number of detected beacons, measures may be taken to improve the detection of beacons, such as keeping the vehicle stopped while images are taken and adjusting the parameters (e.g. exposure time) of the image sensors.

At 705, a sufficient number of beacons have been detected, so the process makes an attempt to identity beacons based on previous position and orientation calculations. If the process recently made a position/orientation calculation based on previously identified beacons, and the vehicle has not moved drastically since that last calculation, then the pixel coordinates of the beacons will not have drastically changed. Therefore, the identity of as beacon is assumed to he the same as a beacon that was previously identified at or near the same pixel coordinates. In addition, since the coordinates and identities of the beacons are stored in the memory of the computing device, an accurate position and orientation estimation of the vehicle allows the process to calculate expected pixel coordinates of all of the beacons. Some beacons can be identified by matching their detected image coordinates to the expected coordinates of beacons.

At 706, the process determines whether a sufficient number of beacons have been identified in order to calculate a position/orientation. Generally, 3-4 beacons are sufficient, if a sufficient number of beacons are identified, the position and orientation of the vehicle are calculated at 708.

At 707, an insufficient number of beacons have been identified, so the process uses the region of interest mode to identify beacons, according to the method previously described. Depending on the partial-frame rate and rate of motion of the vehicle, the vehicle may have to stop in order to identify beacons.

At 708, a sufficient number of beacons have been detected and identified. Directions to beacons are found based on the pixel coordinates of the beacons. Combining, these directions with the three-dimensional coordinates of the beacons allows the resection technique to be used to calculate the position and orientation of the vehicle.

The functions shown at 791 through 798 are repeated at each update cycle.

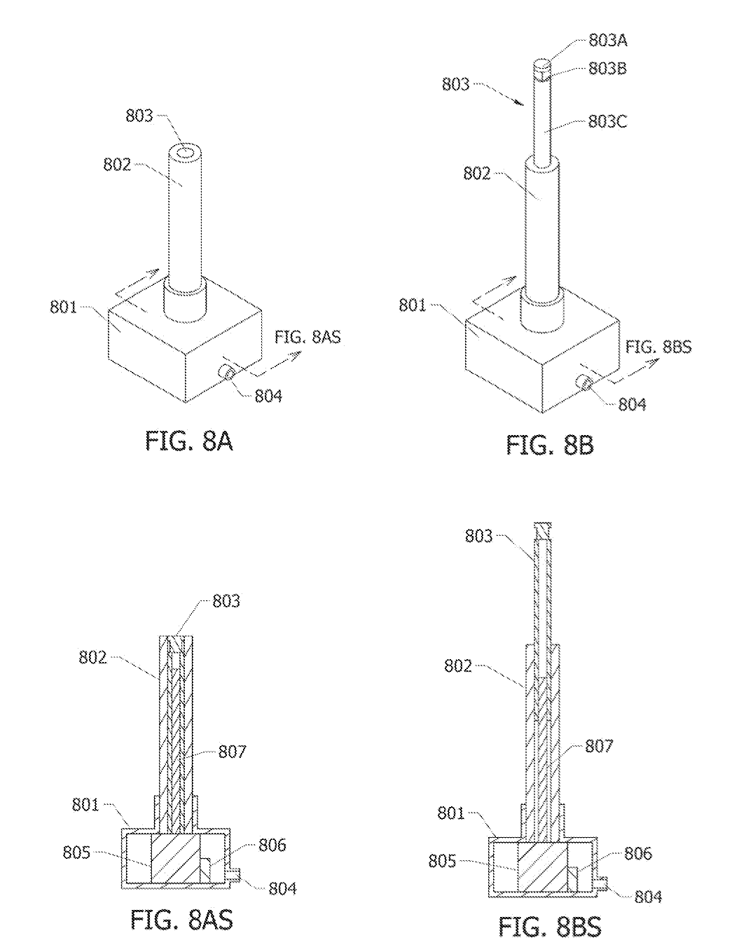

### FIGS. 8, 9, and 10—Second Embodiment

The second embodiment improves upon the foundation by allowing the beacons to he distributed within the working area without interfering with processes that occur within the working area. This is achieved by burying beacons underground and providing a means for them to rise above ground when needed, as well as a means of communication with the beacons.

FIGS. 8A, 8AS, 8B, and 8BS show a particular design for a beacon that can raise itself above ground on command. FIGS. 8A and 8AS show a perspective view and a section view, respectively, of the beacon in a lowered position. In the lowered position, the top of the beacon is flush with the ground. FIGS. 8B and 8BS show a perspective view and a section view, respectively, of the beacon in a raised position.

The beacon is raised and lowered by means of as linear actuator, shown in FIGS. 8AS and 8BS. The linear actuator is composed of an electric motor 805, a screw 807, a fixed tube 802, and a sliding tube 803. The sliding tube is free to move up and down within the fixed tube, but is constrained so that it cannot rotate. The sliding tube is partially threaded and matched with the thread of the screw. The screw is mounted to the electric motor and the electric motor is able to rotate the screw clockwise and counterclockwise. Rotating the motor one way causes the beacon to rise and rotating the motor the other way causes the beacon to lower. Other types of linear actuators may be used, such as hydraulic, pneumatic, and rack and pinion actuators, but the screw type of linear actuator described above has the advantage of being self-locking (i.e. the beacon can remain in a raised position without the electric motor needing to be energized).

The sliding tube 803 is composed of as tube 803 which is partially threaded, a beacon light source 803B, and a top 803A which is flush with the fixed tube 802 when the beacon is in the lowered position.

Next to the electric motor is a beacon controller 806. The beacon controller includes a data processing component, memory, an input for electrical power, two outputs for electrical power (and any required power converters), and a means of communication with the vehicle 100 a beacon network controller which controls all of the beacons in the working area. One output of electrical power is connected to the beacon light source 803B and the other is connected to the electric motor 805. The beacon light source and electric motor are controlled by adjusting the power outputs to which they are connected. The controller receives commands to adjust the height of the beacon and to adjust the emission of the beacon light source over some means of communication, The controller may also communicate its current state and other information over this means of communication. The means of communication may be provided using a data cable or using radio waves.

Surrounding the electric motor and the controller is the housing 801. The housing holds and protects the electric motor and the beacon controller. On one side of the housing is an inlet 804. The inlet allows power and/or data cables to securely enter the housing in order to power the beacon controller and/or to communicate with the beacon controller. Alternatively, the beacon could be powered by a battery and a photovoltaic module and it could communicate using a radio transmitter and receiver.

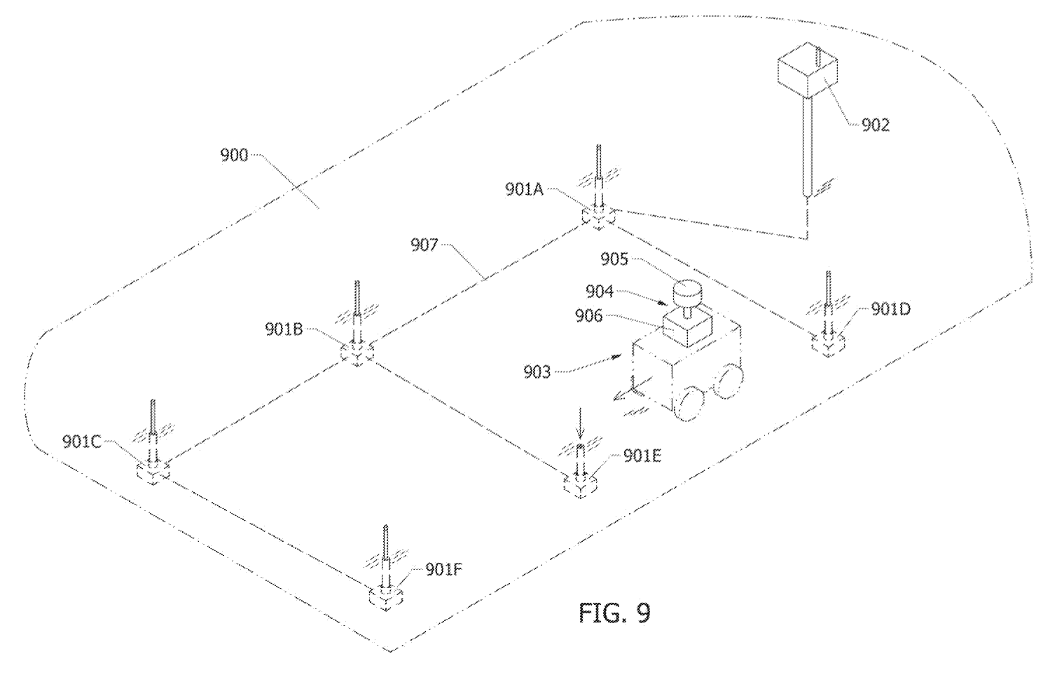

FIG. 9 shows an implementation of buried beacons of the type previously shown in FIG. 8. A vehicle is shown at reference numeral 903 that moves about within a working area shown at reference numeral 900. The working area is an outdoor environment, such as a yard or golf course. The vehicle may be a mobile robot that performs some operation, such as landscaping (e.g. lawn mowing and leaf removal), within the working area.

Beacons 901A, 901B, 901C, 901D, 901E, and 901F are buried into the ground of the working area. The beacons are connected to a network using underground cable 907. The network is also connected to beacon network controller 902. The beacon network controller includes a computing device comprised of a data processing component, memory, a means of communication on the beacon network, and a radio communication device. The beacon network controller address individual beacons and commands them to emit optical signals and to raise and lower themselves. The beacon network controller also receives data and commands from the position sensor over the wireless means of communication.

The position sensor 904 is comprised of an imaging system 905 and a computing device 906. The imaging system and the computing device are the same as previously shown in FIG. 1, but with the computing device also having a radio communication device. The radio communication device is used to communicate with the beacon network controller, and thus indirectly communicate with each beacon. As the vehicle moves about the working area, it continually transmits its position and the path it intends to travel to the beacon network controller. The beacon network controller uses this information to determine which beacons should be in a raised position and which beacons should be in a lowered position. If the distance between the vehicle and a beacon decreases to as certain threshold, the beacon network controller may issue a command for that beacon to lower itself in order to avoid a collision. Alternatively, the beacon network controller may issue a command for a beacon to lower itself when the intended path of the vehicle intersects with the beacon. This is illustrated in FIG. 9; beacon 901E has been lowered because it is in the immediate path of the vehicle.

The beacon network controller may also command all beacons to remain in as lowered position unless they are within line of sight and sufficiently close to the position sensor. This way, only beacons that are useful for the position measurement are raised. Additionally, the beacon network controller may lower beacons that are determined to conflict with any other activity occurring in the working area.

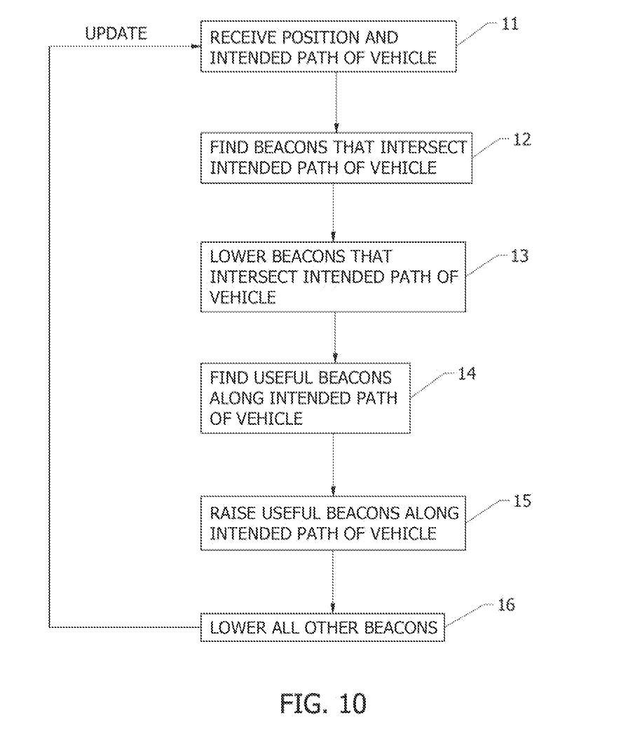

FIG. 10 shows a process for continually adjusting the heights of the beacons, as performed by the beacon network controller. Each update starts at 11, where the beacon network controller receives the position and intended path of the vehicle. The intended path is represented as a series of waypoints and includes the estimated time of arrival for each waypoint.

At 12, the beacon network controller determines whether the intended path of the vehicle intersects with the positions of any beacons. A factor of safety can he applied such that an intersection is defined to occur when a beacon is within a certain distance to the intended path. The beacon network controller also determines the estimated time of arrival of the vehicle at each point of intersection.

At 13, the beacon network controller issues commands for beacons in the intended path of the vehicle to lower themselves. Not every beacon in the intended path of the vehicle needs to lower itself. Instead, only the beacons that will momentarily be intersected by the vehicle need to be lowered. This may be determined by the estimated time of arrival at the point of intersection and the amount of time required to lower the beacon, plus as factor of safety.

At 14, the beacon network controller determines which beacons will be useful in determining the position of the vehicle along its intended path. Beacons must be within line of sight of the position sensor in order to be considered useful. Beacons that were lowered in 13 are not considered useful. Beacons past a certain threshold distance from the position sensor may be considered not useful.

At 15, the beacon network controller issues commands for all beacons considered to be useful to raise themselves. And at 16, the remaining beacons are issued commands to lower themselves. The functions shown at 11 through 16 are repeated at each update cycle.

It is possible to have the position sensor issue commands directly to the beacons instead of having a beacon network controller. In this case, each beacon would require a means of wireless communication with the position sensor, and the position sensor would perform the process shown in FIG. 10.

### FIGS. 1, 2, 3 and 11—Third Embodiment

The third embodiment improves upon the foundation by increasing the signal-to-noise ratio of the beacons. This is achieved by using the atmosphere to filter extraterrestrial light.

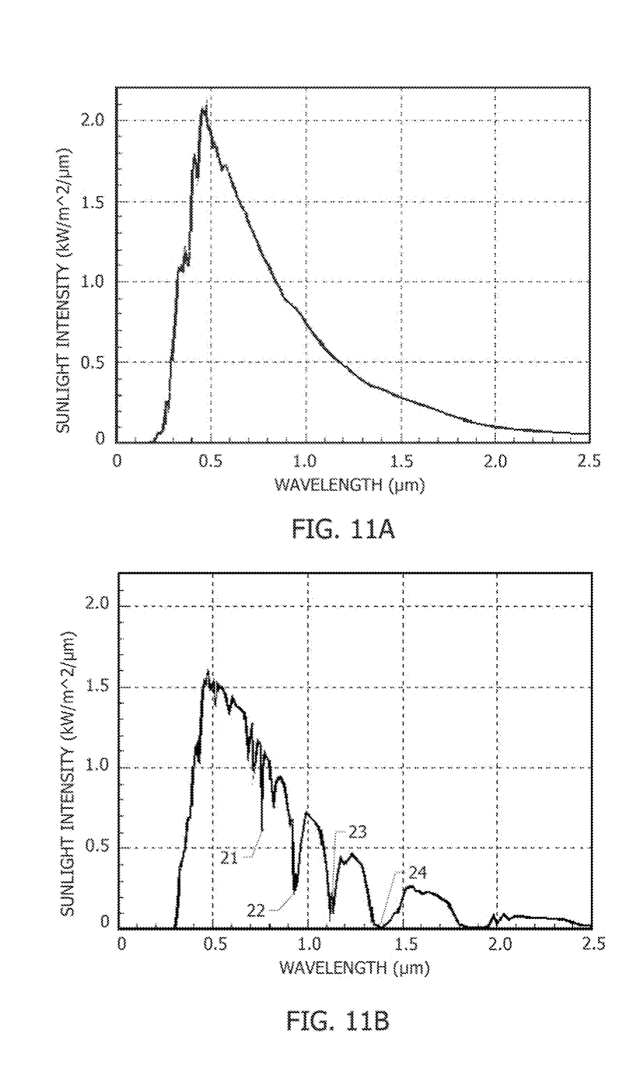

FIG. 11A shows the spectral density of light emitted by the sun, measured above the atmosphere. The x-axis represents the wavelength of light (in terms of micrometers) and the y-axis represents light intensity (in terms of kilowatts per meter squared, per micrometer). FIG. 11B shows the spectral density of light emitted by the sun, measured at sea level. The axes of 11B are the same as FIG. 11A.

As can be seen from FIGS. 11A and 11B, the light intensity at sea level is generally lower across the spectrum, as compared to the light intensity above the atmosphere. The light intensity is especially low at and around wavelengths of 0.76, 0.94, 1.13, and 1.38 micrometers (indicated by reference, numerals 21, 22, 23, and 24, respectively). These are water and oxygen absorption bands in the atmosphere (particularly in the troposphere).

The third embodiment increases the signal to noise ratio of the beacons by operating the beacons at a narrow wavelength within one of these four absorption bands. While the light from the beacons will also be absorbed by the atmosphere, the amount of absorption will be very small compared to sunlight. This is because the distances between beacons and the imaging system 1412 in a resection-based positioning system are very small compared to the distance sunlight travels through the troposphere.

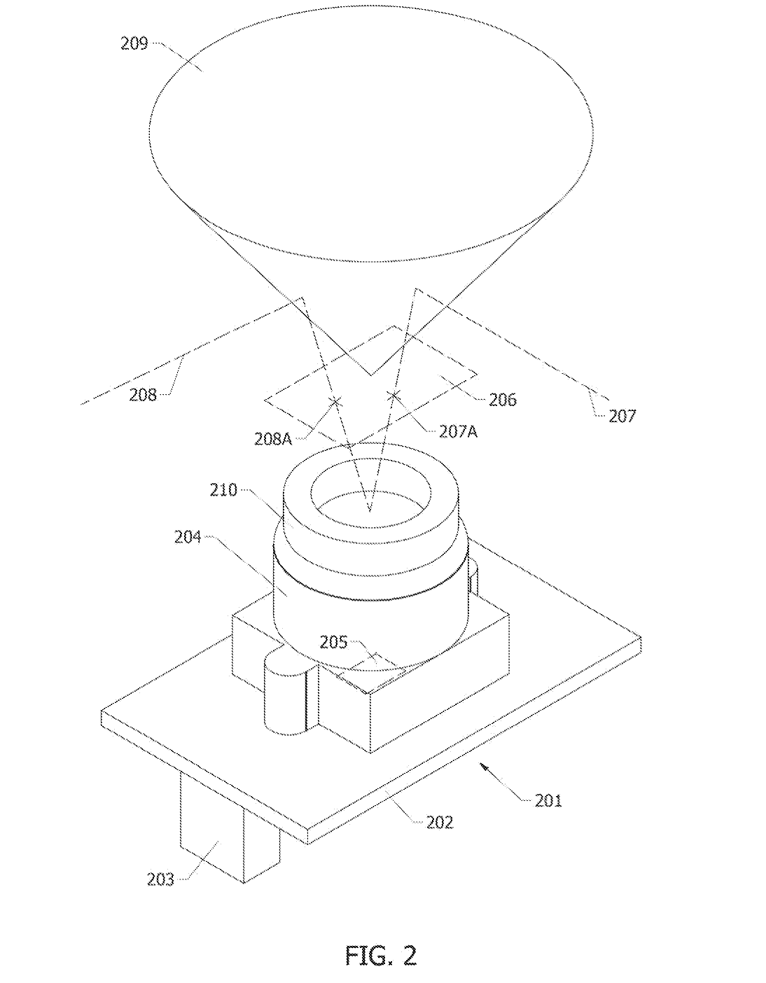

The beacons 101A, 101B, and 101C in FIG. 1A (and any other beacons in the working area) emit light using light emitting diodes. Light emitting diodes are preferred because they can emit light in a narrow spectrum (roughly half the power of the emission within a 20 nanometer band), but any narrow spectrum source can be used. The wavelength of the light emitting diodes is chosen to fall within one of the absorption bands discussed above. The optical filters 210 in FIG. 2 or 309A, 3091 and 309C in FIG. 3 are chosen to be bandpass optical filters, with an allowed wavelength matching the emission spectrum of the light emitting diodes. The optical filters are shown mounted in front of the lens, but they may also be mounted between the lens and the image sensor (205 in FIGS. 2 and 305A, 305B, and 305C in FIG. 3).

I claim:

1. A method for determining the position and orientation of an object within an environment, comprising:
a. a plurality of beacons placed at known positions in the environment, wherein the beacons emit unique and predetermined optical signals patterned in such a way as to
i. appear as a first signal when sampled at a first sampling rate, wherein the first signal is common to all the beacons, and to
ii. appear as a second signal when sampled at a second sampling rate, wherein the second signal is unique for each of the beacons;
b. an imaging device comprising, of at least one image sensor, mounted on the object, and configured to image it field-of-view containing at least one of the beacons:
c. a computing device mounted on the object and configured to derive a position and orientation of the object from data associated with the pixel locations of the beacons within images and file positions or the beacons within the environment.

2. The method of claim 1, wherein the first sampling rate is lower than the second sampling rate.

3. The method of claim 2, wherein the imaging device is configured to
a. capture full frame images of the field-of-view at the first sampling rate and to
b. capture partial frame images of the field-of-view at the second sampling rate.

4. The method of claim 3, wherein the computing device is configured to
a. detect the presence and pixel locations of one or more of the beacons within full frame images by detecting one or more instances of the first signal within a sequence of the full frame images, to
b. instruct the imaging device to capture sequences of partial frame images at the pixel locations of the detected beacons, to
c. identify the beacons within images by detecting the second signal within sequences of the partial frame images, and to
d. derive a position and orientation of the object from data associated with the pixel locations of the beacons within images, the identity of the beacons within images, and the positions of the beacons within the environment.

5. A method for determining the position and orientation of an object within an environment, comprising:
a. a plurality of beacons placed at known positions in the environment, wherein the beacons are configured to
i. be installed substantially underground and to
ii. have a means of rising above the ground and lowering back underground:
b. an imaging device comprising of at least one image sensor, mounted on the object, and configured to image a field-of-view containing at least one of the beacons:
c. a computing device mounted on the object and configured to derive a position and orientation of the object from data associated with the pixel locations of the beacons within images and the positions of the beacons within the environment.

6. The method of claim 5, wherein data about the position and intended path of the object is used to determine which of the beacons should be raised and which of the beacons should be lowered.

7. The method of claim 6, wherein the computing device mounted on the object determines which of the beacons should be raised and which of the beacons should be lowered.

8. The method of claim 7, wherein
a. the computing device mounted on the object wirelessly transmits commands to the beacons indicating whether to raise or lower themselves;
b. the beacons have a means of receiving wireless data.

9. The method of claim 5, wherein
a. one or more beacon network controllers arc connected to the beacons;
b. the beacon network controllers have a means of causing individual beacons to raise and lower themselves.

10. The method of claim 6, wherein
a. one or more beacon network controllers are connected to the beacons;
b. the beacon network controllers have a means of causing individual beacons to raise and lower themselves.

11. The method of claim 10, wherein
a. the beacon network controllers have a means of receiving wireless data about the position and intended path of the object, from the computing device mounted on the object;
b. the computing devices in the beacon network controllers determines which of the beacons should be raised and which of the beacons should be lowered.

12. The method of claim 10. wherein
a. the computing device mounted on the object determines which of the beacons should be raised and which of the beacons should be lowered:
b. the computing device mounted on the object wirelessly transmits commands to the beacon network controllers to lower and raise the beacons.

13. A method for determining, the position and orientation of an object within an environment, comprising:
a. a plurality of beacons placed at known positions in the environment, wherein the beacons emit light substantially within an absorption band of Earth's atmosphere
b. an imaging device mounted on the object, comprising of at least one image sensor and at least one optical bandpass filter with an allowed wavelength substantially matching the emission of the beacons, and configured to image a field-of-view containing at least one of the beacons;
c. a computing device mounted on the object and configured to derive a position and orientation of the object from data associated with the pixel locations of the beacons within images and the positions of the beacons within the environment.

14. The method of claim 7, wherein at least half of the emission of the beacons has a wavelength within 15 nanometers of 940 nanometers,

15. The method of claim 7, wherein at least half of the emission of the beacons has a wavelength within 15 nanometers of 760 nanometers.

16. The method of claim 7, wherein at least half of the emission of the beacons has a wavelength within 15 nanometers of 1,130 nanometers.

17. method of claim 7, wherein at least half of the emission of the beacons has a wavelength within 15 nanometers of 1,380 nanometers.
